(19) United States
(12) Patent Application Publication
(10) Pub. No.: US 2008/0080055 A1
(43) Pub. Date: Apr. 3, 2008

(54) Diffuse reflector comprising nonwoven sheet with binder layer comprising binder and scatterer of visible light

(76) Inventors: Edwin James Lightfoot, Amherst, NY (US); William George O'Brien, Newark, DE (US); Adam Ben Starry, Kennett Square, PA (US); Robert William Johnson, Kennett Square, PA (US); William John Gambogi, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/903,916

(22) Filed: Sep. 25, 2007

Related U.S. Application Data
(60) Provisional application No. 60/848,206, filed on Sep. 29, 2006.

(51) Int. Cl. G02B 5/02

(52) U.S. Cl. 359/599

(57) ABSTRACT

This invention relates to diffuse reflectors of visible light comprising a nonwoven sheet having on at least one face thereof a binder layer comprising a binder and a scatterer of visible light dispersed in the binder. These diffuse reflectors have utility in light management in optical displays such as backlit LCD displays for lap top computers and televisions.

### BACKGROUND

1. Field of the Invention

The present invention relates to a diffuse reflector of visible light comprising a nonwoven sheet having on at least one face thereof a binder layer comprising a binder and a scatterer of visible light dispersed in the binder.

2. Description of Related Art

Special light reflectant surfaces are used in a variety of applications requiring visible light to be almost completely reflected while providing an even distribution of light from the surface. While mirrored surfaces can provide nearly perfect reflectivity of visible light, the light energy exiting these surfaces does so only at an angle equal to the incident angle. For many applications it is important that visible light be reflected from a surface in a distribution. This property is referred to as diffuse or Lambertian reflectance. Lambertian reflection of light is the uniform diffuse reflection of light from a material in all directions with no directional dependence for the viewer according to Lambert's cosine law. Diffuse reflection originates from a combination of external scattering of light from features on the surface of a material, and internal scattering of light from features within a material. Internal light scattering can arise, for example, from features within a material such as pores and particles. The light scattering cross section per unit feature volume of materials containing closely spaced refractive index inhomogeneity is maximized when the mean diameter of the features is slightly less than one-half the wavelength of the incident light. The degree of light scattering is also increased when there is a large difference between the refractive index of the scattering feature and refractive index of the phase in which the feature is dispersed.

Diffuse reflectivity of visible light is critical in many applications. Direct view displays used in electronic equipment (e.g., instrument panels, portable computer screens, liquid crystal displays (LCDs)), whether relying on supplemental lights (e.g., backlight) or ambient light, require diffuse reflectant back surfaces to maximize image quality and intensity. Reflectivity is particularly critical with backlit direct view displays in battery powered equipment, where reflectivity improvements directly relate to smaller required light sources and thus lower power demands.

Portable computer LCDs are a substantial and demanding market requiring high levels of diffuse reflection of visible light from very thin materials. For certain markets it is critical that the backlight reflector is relatively thin, i.e., less than 250 μm and often less than 150 μm, to minimize the thickness of the completed display.

The reflective material used in LCD backlights has a significant effect on the brightness, uniformity, color and stability of the backlight unit and, ultimately, the LCD module. For a direct view LCD backlight, requirements for the reflector include high photopic reflectance (e.g., >95%) and high stability under use conditions including cavity temperatures of 50 to 70° C., high stability to ultraviolet (UV) light from cold cathode fluorescent lamp (CCFL) sources, high humidity and temperature cycling. In direct view backlights, the reflector is an integral part of the backlight unit and, therefore, the physical properties of the material are also important. Requirements for an edge lit backlight differ in that the operating temperature is typically lower and the need for UV stability is less due to the UV absorption in the light guide. However, additional requirements on edge lit backlight reflectors include the need to make uniform contact with the light guide without damaging it, and minimizing reflector thickness.

Due to the many different applications that exist for reflectant materials, it is not surprising that there are a wide variety of commercially available products with an array of diffuse reflective properties. Major industrial efforts are underway to fabricate reflector sheet stock used to enhance the image quality of LCD screens in a variety of evolving electronic optical display devices. An industry standard diffuse reflective material is described in U.S. Pat. No. 4,912,720 and sold under the trademark SPECTRALON® by Labsphere, Inc., North Sutton, N.H., USA. This material comprises lightly packed granules of polytetrafluoroethylene having a void volume of about 30% to 50% and is sintered into a relatively hard cohesive block so as to maintain such void volume. Using the techniques taught by U.S. Pat. No. 4,912,720, it is asserted that exceptionally high diffuse visible light reflectance characteristics can be achieved with this material, with photopic reflectance over the visible wavelengths of light of better than 99%. Despite the advantages of such material, it is not generally available in very thin films of less than 250 μm, such as those needed for the laptop LCD market, and furthermore at these thickness levels, adequate reflection performance is not obtained.

Gore™ DRP®, produced by W. L. Gore & Associates, Inc., DE, USA, is a reflectant material of expanded polytetrafluoroethylene (PTFE) comprising polymeric nodes interconnected by fibrils defining a microporous structure. This material is highly flexible and has excellent diffuse reflectant properties. Its shortcoming is significantly higher cost.

Filled microvoided poly(ethylene terephthalate) (PET) films, also referred to in this field as “white PET”, are commercial diffuse reflectors used in optical display applications. These materials are sold in different thickness with reflectivity varying with thickness. White PET films around 190 μm thick find utility in notebook personal computer (PC) LCDs and desktop PC LCDs. These films typically have an average reflectance in the visible light wavelengths of about 95%. An about 190 μm thick white PET reflector is sold by Toray Industries, Inc. of Chiba, Japan, commercially available as “E60L”. However, E60L suffers from poor resistance to UV radiation and requires a UV coating which raises the cost of the reflector. Further, white PET films rely on precise addition of optical quality inorganic fillers in properly melt blended concentration and uniformity, involving high pressure filtration as well as hot casting, stretching and other laborious techniques needed to achieve basic functional film properties independent of necessary optical performance and consistency. Due to such process complexity, the development of new melt-based white PET films are undesirably difficult, costly, and lengthy endeavors.

U.S. Pat. No. 5,976,686 discloses a light conduit containing a 150 μm to 250 μm thick nonwoven polyethylene fabric diffuse light reflector. However, such materials were reported to have an average reflectance varying from 77% to 85%, depending on the thickness, over the wavelength range of 380 to 720 nm. This patent disparages both the random fiber construction of the nonwoven and its variation in thickness as being adversely noticeable in this application and discloses these reflectors in comparative examples.

U.S. patent application publication US 2006/0262310 A1 discloses an article containing a diffuse reflector of light comprising a nonwoven sheet containing a plurality of pores The diffuse reflector is disclosed as having a high photopic reflectance of visible light. Multiple layers of this nonwoven sheet as a laminated multilayer reflector offers a low cost alternative to established film-based reflectors. However, weaknesses of this approach center on the nonwoven sheet and nonwoven sheet laminate thickness, thickness non-uniformity, visual surface appearance and dimensional stability relative to polyester film competitors.

Thus, unique opportunities exist to further enhance the performance of nonwoven sheet diffuse reflectors. Improved and inexpensive diffuse reflectors are needed for visible light management applications that will allow for production of more affordable and energy efficient optical displays.

### BRIEF SUMMARY

A new diffuse reflector for optical display backlights has been developed and is of utility in direct view and edgelit optical display backlight applications. These diffuse reflectors having high photopic reflectance, less visual nonuniformity, high diffusivity and reduced thickness variability. These diffuse reflectors create a more uniform reflector back surface for device bonding and offer the ability to increase thickness and thereby photopic reflectance to match reflector needs.

Briefly stated, and in accordance with one aspect of the present invention, there is provided a diffuse reflector of visible light comprising a nonwoven sheet having on at least one face thereof a binder layer containing a binder and a scatterer of visible light dispersed in the binder.

Pursuant to another aspect of the present invention, there is provided a diffuse reflective article comprising a diffuse reflector of visible light and a structure forming an optical cavity, wherein the diffuse reflector has a nonwoven face and is positioned within the optical cavity such that light reflects off of the nonwoven face, and wherein the diffuse reflector comprises a nonwoven sheet having on one face thereof a binder layer comprising a binder and a scatterer of visible light dispersed in the binder.

Pursuant to another aspect of the present invention, there is provided an optical display, comprising: (i) a structure defining an optical cavity; (ii) a light source positioned within the optical cavity; (iii) a display panel through which light from the light source passes; and (iv) a diffuse reflector comprising a nonwoven sheet having on one face thereof a binder layer comprising a binder and a scatterer of visible light dispersed in the binder, the diffuse reflector positioned within the optical cavity to reflect light from the light source off of the nonwoven face of the diffuse reflector toward the display panel.

Pursuant to another aspect of the present invention, there is provided a method of improving light reflectivity in a device requiring diffuse reflectivity of light comprising: (i) providing a diffuse reflector comprising a nonwoven sheet having on at least one face thereof a binder layer comprising a binder and a scatterer of visible light dispersed in the binder; and (ii) positioning the diffuse reflector within the device to cause light energy to reflect off of the nonwoven face of the diffuse reflector.

### FIGURES

The invention will be more fully understood from the following detailed description, taken in connection with the accompanying drawings, in which:

FIG. 1 is a cross sectional view of an edge-lit liquid crystal optical display utilizing a diffuse reflector according to the present invention.

FIG. 2 is a cross sectional view of a backlit liquid crystal optical display with a cold cathode fluorescent lamp light source utilizing a diffuse reflector according to the present invention.

FIG. 3 is a graph of reflectivity (%) versus wavelength (nm) for diffuse reflectors of the present invention, and a nonwoven sheet utilized in diffuse reflectors according to the present invention.

FIG. 4 is a graph of center luminance (cd/m²) versus data point (20 second interval) for a backlight unit containing diffuse reflectors of the present invention, and comparative diffuse reflectors.

FIG. 5 contains four radial graphs of luminance versus angle for diffuse reflectors of the present invention, and comparative diffuse reflectors.

FIG. 6 is a graph of normalized luminance versus angle with respect to specular at 20° (deg) for diffuse reflectors of the present invention, and comparative diffuse reflectors.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

### DETAILED DESCRIPTION

The term “visible light” as used herein means electromagnetic radiation in the visible light portion of the spectrum, from 380 nm to 780 nm wavelength. Unless stated otherwise, “photopic reflectance” (R_{VIS}) of light herein means the reflectance (i.e., diffuse and specular reflectance) as seen by a human observer over the visible light wavelength range of 380 nm to 780 nm. Photopic reflectance (R_{VIS}) is calculated from total reflectance spectral data using illuminant D65 and the CIE Standard Photopic observer described in “Billmeyer and Saltzman Principles of Color Technology”, 3^{rd} Edition.

The diffuse reflector of the present invention comprises a nonwoven sheet. Nonwoven sheet and nonwoven web as used herein means a structure comprising individual fibers that are formed and then positioned in a random manner to form a planar material comprising the fibers without an identifiable pattern and without knitting or weaving. As used herein, the term fiber is intended to include all different types of fibrous materials that can be used to make nonwoven sheets. They include staple fibers used for carding, wet-lay, air-lay and dry-forming; continuous or discontinuous filaments made by melt spinning, solution spinning, melt blowing; plexifilamentary film-fibrils obtained by flash spinning; and fibrids prepared by fibridation processes. Examples of nonwoven sheets include spunbond webs, melt blown webs, multi-directional, multi-layer carded webs, air-laid webs, wet-laid webs, spunlaced webs and composite webs comprising more than one nonwoven sheet. As used herein, the term nonwoven sheet does not include paper made from wood pulp or fabrics that are woven, knitted or tufted, nor does it include films.

Nonwoven sheet for diffuse reflectors of the present invention preferably comprises flash-spun fibers. The term flash-spun fibers as used herein means fibers produced by the following general process, also disclosed in U.S. Pat. No. 3,860,369. As disclosed in this patent, flash-spinning is conducted in a chamber, sometimes referred to as a spin cell, which has a vapor-removal port and an opening through which non-woven sheet material produced in the process is removed. Polymer solution (or spin liquid) is continuously or batchwise prepared at an elevated temperature and pressure and provided to the spin cell. The pressure of the solution is greater than the cloud-point pressure, which is the lowest pressure at which the polymer is fully dissolved in the spin agent forming a homogeneous single phase mixture. The single phase polymer solution passes through a letdown orifice into a lower pressure (or letdown) chamber. In the lower pressure chamber, the solution separates into a two-phase liquid-liquid dispersion. One phase of the dispersion is a spin agent-rich phase which comprises primarily spin agent and the other phase of the dispersion is a polymer-rich phase which contains most of the polymer. This two phase liquid-liquid dispersion is forced through a spinneret into an area of much lower pressure (preferably atmospheric pressure) where the spin agent evaporates very rapidly (flashes), and the polymer emerges from the spinneret as plexifilaments.

The term plexifilamentary or plexifilaments as used herein means a three-dimensional integral network of a multitude of thin, ribbon-like, film-fibrils of random length and with a mean fibril thickness of less than about 4 μm and a median width of less than about 25 μm. In plexifilamentary structures, the film-fibrils are generally coextensively aligned with the longitudinal axis of the structure and they intermittently unite and separate at irregular intervals in various places throughout the length, width and thickness of the structure to form a continuous three-dimensional network. Such structures are described in further detail in U.S. Pat. No. 3,081,519 and in U.S. Pat. No. 3,227,794.

The plexifilaments are stretched in a tunnel and are directed to impact a rotating baffle. The rotating baffle has a shape that transforms the plexifilaments into a flat web, which is about 5-15 cm wide, and separates the fibrils to open up the web. The rotating baffle further imparts a back and forth oscillating motion having sufficient amplitude to generate a wide back and forth swath. The web is laid down on a moving wire laydown belt located below the spinneret, and the back and forth oscillating motion is arranged to be generally across the belt to form the nonwoven sheet.

As the web is deflected by the baffle on its way to the moving belt, it enters a corona charging zone between a stationary multi-needle ion gun and a grounded rotating target plate. The multi-needle ion gun is charged to a DC potential by a suitable voltage source. The charged web is carried by a high velocity spin agent vapor stream through a diffuser consisting of two parts: a front section and a back section. The diffuser controls the expansion of the web and slows it down. Aspiration holes are drilled in the back section of the diffuser to assure adequate flow of gas between the moving web and the diffuser back section to prevent sticking of the moving web to the diffuser back section. The moving belt is grounded so that the charged web is electrostatically attracted to the belt and held in place thereon.

Overlapping web swaths from a multiplicity of plexifiliments are collected on the moving belt and held there by electrostatic forces and formed into the nonwoven sheet of the width desired with a thickness controlled by the belt speed. The sheet is then consolidated which involves compressing the sheet between the belt and a consolidation roll into a structure having sufficient strength to be handled outside the chamber. The sheet is then collected outside the chamber on a windup roll. The sheet can be bonded using methods known in art, such as thermal bonding.

Thermal bonding relates to conventional processes in which at least one surface of a consolidated nonwoven sheet comprising polymer is heated, typically to a temperature at or slightly below the polymer melting point, while applying force normal to the face of the sheet. Under such conditions, polymer at points of contact on the surface of separate fibers at the sheet surface will mix and form a bonding point (bond) which secures the fibers together. The contact time between a heat source (e.g., a heated roll) and the consolidated nonwoven sheet is very small because of the high speed of the thermal bonding step, such that only the surface fibrils of the consolidated nonwoven sheet reach a temperature close to the melting temperature of the polymer. This is indicated by the fibrils only at the surface of the resultant non-woven sheet adhering together at bonding points between intersecting fibers. Known methods for thermal bonding of nonwovens includes hot-air bonding on a tenter frame, pressing between heated platens, bonding while restrained against a hot roll by a heavy blanket, calendering with hot rolls and point-bonding with embossed rolls.

Nonwoven sheets for diffuse reflectors of the present invention include those comprising spunbond fibers. The term spunbond fibers as used herein means fibers that are melt-spun by extruding molten polymer as fibers from a plurality of fine, usually circular, capillaries of a spinneret with the diameter of the extruded fibers then being rapidly reduced by drawing and then quenching the fibers. Other fiber cross-sectional shapes such as oval, tri-lobal, multi-lobal, flat, hollow, etc. can also be used. Spunbond fibers are generally substantially continuous and usually have an average diameter of greater than about 5 μm. Spunbond nonwoven webs are formed by laying spunbond fibers randomly on a collecting surface such as a screen or belt, and are bonded using methods known in art, such as thermal bonding.

Nonwoven sheets for diffuse reflectors of the present invention include those comprising melt blown fibers. The term melt blown fibers as used herein means fibers that are melt-spun and then attenuated by melt blowing, which comprises extruding a melt-processible polymer through a plurality of capillaries as molten streams into a high velocity gas (e.g., air) stream. The high velocity gas stream attenuates the streams of molten polymer to reduce their diameter and form melt blown fibers having a diameter between about 0.5 μm and about 10 μm. Melt blown fibers are generally discontinuous fibers but can also be continuous. Melt blown fibers carried by the high velocity gas stream are generally deposited on a collecting surface to form a melt blown web of randomly dispersed fibers. Melt blown fibers can be tacky when they are deposited on the collecting surface, which generally results in bonding between the melt blown fibers in the melt blown web. Melt blown webs can also be bonded using methods known in the art, such as thermal bonding.

Nonwoven sheets for diffuse reflectors of the present invention include those comprising staple-based nonwovens. Staple-based nonwovens can be prepared by a number of methods known in the art, including carding or garneting, air-laying, or wet-laying of fibers and the staple-based nonwovens can be needlepunched, spunlaced, thermal bonded and chemical bonding. The staple fibers preferably have a denier per fiber between about 0.5 and about 6.0 and a fiber length of between about 0.25 inch (0.6 cm) and about 4 inches (10.1 cm).

Nonwoven sheets for diffuse reflectors of the present invention include those comprising wet-laid fibrids as disclosed in U.S. Pat. No. 2,999,788.

Polymers from which nonwoven sheets for diffuse reflectors of the present invention can be made, include polyolefin (e.g., polyethylene, polypropylene, polymethylpentene and polybutylene), acrylonitrile-butadiene-styrene (ABS) resin, polystyrene, styrene-acrylonitrile, styrene-butadiene, styrene-maleic anhydride, vinyl plastic (e.g., polyvinyl chloride (PVC)), acrylic, acrylonitrile-based resin, acetal, perfluoropolymer, hydrofluoropolymer, polyamide, polyamide-imide, polyaramid, polyarylate, polycarbonate, polyesters, (e.g., polyethylene napthalate (PEN)), polyketone, polyphenylene ether, polyphenylene sulfide and polysulfone. Preferred amongst the polymers are polyolefins.

In the context of polymers from which nonwoven sheets according to the present invention can be made, the term polyolefin as used herein means any of a series of largely saturated open chain polymeric hydrocarbons consisting of carbon and hydrogen. Typical polyolefins include, but are not limited to, polyethylene, polypropylene and polymethylpentene. Polyethylene and polypropylene are preferred.

In the context of polymers from which nonwoven sheets according to the present invention can be made, the term polyethylene as used herein includes not only homopolymers of ethylene, but also copolymers wherein at least 85% of the recurring units arise from ethylene. A preferred polyethylene is linear high density polyethylene having an upper limit of melting range of about 130° to 137° C., a density in the range of 0.94 to 0.98 g/cm³ and a melt index (as defined by ASTM D-1238-57T, Condition E) of between 0.1 to 100, preferably between 0.1 and 4.

In the context of polymers from which nonwoven sheets according to the present invention can be made, the term polypropylene as used herein includes not only homopolymers of propylene but also copolymers wherein at least 85% of the recurring units arise from propylene units.

Preferred nonwoven sheets for diffuse reflectors of the present invention comprise a consolidated sheet of flash-spun plexifilamentary film-fibrils, wherein the fibrils comprise polymer containing pores. The polymer preferably comprises polyolefin, especially polyethylene.

Diffuse reflectance of visible light by nonwoven sheets of utility in diffuse reflectors according to the present invention arises from a combination of light scattering from pores created by fiber interstices, and light scattering from pores within the fibers. Nonwoven sheets contain a plurality of pores that are defined herein as intra-fiber pores or inter-fiber pores. Intra-fiber pores are randomly distributed throughout the interior of a fiber and have a mean pore diameter as measured by mercury porosimetry ranging from about 0.02 μm to about 0.5 μm. Inter-fiber pores are randomly distributed interstices between fibers in a nonwoven sheet and have a mean pore diameter as measured by mercury porosimetry ranging from about 0.5 μm to about 9 μm. The visible light scattering cross section per unit pore volume, and thus diffuse reflectance, of nonwoven sheets is maximized for pores having a mean pore diameter of from about 0.2 μm to about 0.4 μm, slightly less than one-half the wavelength of visible light. About one third of the light scattering by nonwoven sheets of utility in diffuse reflectors according to the present invention arises from inter-fiber pores having a mean pore diameter of about 1 μm and larger, and that about two thirds of the light scattering arises from the intra-fiber pores and inter-fiber pores having a mean pore diameter of less than about 1 μm.

“Specific pore volume” (also referred to herein as “SPV”) is herein defined as the mathematical product of the nonwoven sheet average basis weight, in units of g/m², times pore volume, in units of cm³/g, for a given mean pore diameter range. SPV has units of cm³/m², and is a unit characterizing the volume of pores for a given mean pore diameter range that exists per square area of nonwoven sheet. Average basis weight is measured by the procedure of ASTM D3776, modified as appropriate for nonwoven sheet size. Nonwoven sheet pore volume for a given mean pore diameter range is obtained by known mercury porosimetry methodology as disclosed by H. M. Rootare in “A Review of Mercury Porosimetry” from Advanced Experimental Techniques in Powder Metallurgy, pp. 225-252, Plenum Press, 1970. “VP1” is herein defined as the volume of nonwoven sheet pores as measured by mercury porosimetry having a mean pore diameter of from 0.01 μm to 1.0 μm.

“VP2” is herein defined as the volume of nonwoven sheet pores as measured by mercury porosimetry having a mean pore diameter of from 0.02 μm to 0.5 μm. SPV1 is herein defined as the specific pore volume relating to the VP1 mean pore diameter range, and SPV2 is herein defined as the specific pore volume relating to the VP2 mean pore diameter range.

A plot of nonwoven sheet photopic reflectance (%) of visible light by the spectrophotometer method versus specific pore volume (SPV) yields a smooth curve for nonwoven sheets of utility in diffuse reflectors according to the present invention. SPV1 of about 10 cm³/m² results in a photopic reflectance of visible light by the spectrophotometer method of at least about 85% for the nonwoven sheet. SPV1 of about 20 cm³/m² results in a photopic reflectance by the spectrophotometer method of at least about 90%. SPV1 of about 30 cm³/m² results in a photopic reflectance by the spectrophotometer method of at least about 92%. SPV1 of about 40 cm³/m² results in a photopic reflectance by the spectrophotometer method of at least about 94%. SPV1 of about 50 cm³/m² results in a photopic reflectance by the spectrophotometer method of at least about 96%.

Intra-fiber pores have a high scattering cross section per unit pore volume, and thus are primarily responsible for the high light scattering, and thus high diffuse reflectance, of the nonwoven sheets of utility in diffuse reflectors according to the present invention. Nonwoven sheets contain a plurality of intra-fiber pores, and SPV2 of about 7 cm³/m² results in a photopic reflectance of visible light by the spectrophotometer method of at least about 85% for the nonwoven sheet. SPV2 of about 16 cm³/m² results in a photopic reflectance by the spectrophotometer method of at least about 90%. SPV2 of about 25 cm³/m² results in a photopic reflectance by the spectrophotometer method of at least about 92%. SPV2 of about 30 cm³/m² results in a photopic reflectance by the spectrophotometer method of at least about 94%. SPV2 of about 40 cm³/m² results in a photopic reflectance by the spectrophotometer method of at least about 96%.

Nonwoven sheets of utility in diffuse reflectors according to the present invention contain a plurality of pores, wherein SPV1 is generally at least about 10 cm³/m², resulting in a photopic reflectance of visible light by the spectrophotometer method of at least about 85% for the nonwoven sheet. SPV1 is preferably at least about 20 cm³/m², more preferably at least about 30 cm³/m², even more preferably at least about 40 cm³/m², and most preferably at least about 50 cm³/m². Intra-fiber pore related SPV2 is generally at least about 7 cm³/m², resulting in a photopic reflectance by the spectrophotometer method of at least about 85%. SPV2 is preferably at least about 16 cm³/m², more preferably at least about 25 cm³/m², even more preferably at least about 30 cm³/m², and most preferably at least about 40 cm³/m².

The photopic reflectance of nonwoven sheets of utility in diffuse reflectors according to the present invention decreases with increased thermal bonding. Thermal bonding undesirably reduces the volume of nonwoven sheet intra-fiber pores having a high scattering cross section per unit pore volume that contribute substantially to diffuse reflectance. Thermal bonding also undesirably reduces the volume of nonwoven sheet inter-fiber pores that also contribute to the diffuse reflectance. Thus, nonwoven sheet of utility in diffuse reflectors according to the present invention is preferably not thermal or otherwise bonded. Such nonwoven sheet is consolidated, and can contain a minimal degree of thermal or other bonding on the nonwoven sheet surface necessary to maintain structural integrity of the sheet during diffuse reflector handling and use where consolidation of the nonwoven web alone is not sufficient.

The preferred embodiment plexifilamentary film-fibril polyolefin nonwoven sheets for diffuse reflectors of the present invention will have maximal volume of inter-fiber and intra-fiber pores, and thus high photopic reflectance, and maintain sufficient structural integrity during diffuse reflector handling and use, if bonding of the nonwoven sheet is carried out such that the bonded sheet has a delamination value of about 7.1 kg/m (0.4 lb/in) or less, preferably about 5.3 kg/m (0.3 lb/in) or less, more preferably about 5.0 kg/m (0.28 lb/in) or less, and most preferably about 1.8 kg/m (0.1 lb/in) or less. Delamination is a measurement reported in units of force/length (e.g., kg/m) defined by ASTM D 2724 and relates to the extent of bonding in certain types of sheet, for example bonding in nonwoven sheet made from plexifilamentary film-fibrils.

The scattering and diffuse reflection of light by nonwoven sheets of utility in diffuse reflectors according to the present invention is due to reflection of light at air-polymer interfaces of the inter-fiber and intra-fiber pores. Reflection will increase with an increase in the difference between the refractive index of the pore phase (air, refractive index of 1.0) and the refractive index of the fiber polymer phase. An increase in light scattering is observed typically when the difference in refractive index between two phases is greater than about 0.1. Polymer comprising the nonwoven sheet fibers preferably has a high refractive index (for example polyethylene, refractive index of 1.51) and low absorption of visible light.

The diffuse reflectance exhibited by nonwoven sheets of utility in diffuse reflectors according to the present invention is a result of their high light scattering ability. However, high photopic reflectance of the nonwoven sheets is achieved by a combination of high light scattering ability together with very low absorption of visible light. One main negative impact of high light absorption by a nonwoven sheet is that the reflectance benefit afforded by higher sheet basis weight is greatly reduced. Thus, nonwoven sheet of utility in diffuse reflectors according to the present invention have very low absorption of visible light and preferably do not absorb visible light. To avoid negative effects of light absorption, nonwoven sheets generally have an absorption coefficient of visible light less than about 10⁻⁴ μm⁻¹, preferably less than about 10⁻⁵ μm⁻¹. Polymers of utility for forming nonwoven sheet of utility in diffuse reflectors according to the present invention generally have an absorption coefficient of about 10⁻⁴ m²/g or less, preferably about 10⁻⁵ m²/g or less, and more preferably about 10⁻⁶ m²/g or less.

Nonwoven sheets comprising the present laminate reflector embodiment diffuse reflectors have a sheet thickness of from about 20 μm to about 1,000 μm, generally less than about 250 μm, and preferably from about 70 μm to about 150 μm. Nonwoven sheets comprising the present single-sheet reflector embodiment diffuse reflectors have a sheet thickness of from about 150 μm to about 300 μm, and preferably from about 150 μm to about 250 μm. In the laminate embodiment, the laminate thickness and therefore the diffuse reflector can be 1,000 μm or greater. Even though such a thickness may not be preferred in certain small optical display applications where space and diffuse reflector thickness is a premium (e.g., cell phones, hand held devices, and the like where thinner devices are preferred), such diffuse reflectors have definite utility in optical display applications where diffuse reflector thickness is less of a concern (e.g., larger flat panel LCD televisions and monitors, luminaires, copying machines, projection display light engines, integrating sphere uniform light sources, and the like).

Nonwoven sheets of utility in diffuse reflectors according to the present invention can further comprise particulate filler dispersed in the polymer phase forming the nonwoven sheet fibers. Nonwoven sheet particulate fillers of utility will have a refractive index larger than that of the polymer and thus light scattering of the nonwoven sheet will increase with an increase in the difference between the refractive index of the particulate filler and the refractive index of the fiber polymer phase. Nonwoven sheet particulate fillers of utility have a high refractive index, high light scattering cross section and low absorption of visible light. Nonwoven sheet particulate filler enhances light scattering and thereby its use can provide higher photopic reflectance for a given nonwoven sheet thickness. Nonwoven sheet particulate fillers can be any shape and have a mean diameter of from about 0.01 μm to about 1 μm, preferably from about 0.2 μm to 0.4 μm. Nonwoven polymer sheets containing nonwoven sheet particulate filler comprise at least about 50% by weight polymer, and nonwoven sheet particulate filler comprises from about 0.05 weight % to about 50 weight %, preferably 0.05 weight % to about 15 weight %, based on the weight of the polymer. Example nonwoven sheet particulate filler includes silicates, alkali metal carbonates, alkali earth metal carbonates, alkali metal titanates, alkali earth metal titanates, alkali metal sulfates, alkali earth metal sulfates, alkali metal oxides, alkali earth metal oxides, transition metal oxides, metal oxides, alkali metal hydroxides and alkali earth metal hydroxides. Specific examples include titanium dioxide, calcium carbonate, clay, mica, talc, hydrotalcite, magnesium hydroxide, silica, silicates, hollow silicate spheres, wollastonite, feldspar, kaolin, magnesium carbonate, barium carbonate, magnesium sulfate, barium sulfate, calcium sulfate, aluminum hydroxide, calcium oxide, magnesium oxide, alumina, asbestos powder, glass powder and zeolite. Preferred amongst the particulate fillers is titanium dioxide. Known methods can be used to make nonwoven sheets containing particulate filler, such as those disclosed in U.S. Pat. No. 6,010,970 and PCT publication number WO2005/98,119.

Nonwoven sheets of utility in diffuse reflectors according to the present invention can be surface roughened by corona and/or plasma treatment to assist adhering the nonwoven sheets to other materials. For example, such treatment aids adhesive lamination and results in better adhesion of a nonwoven sheet to the binder layer.

The diffuse reflector of the present invention includes a binder layer. A first binder layer embodiment (herein also referred to as the laminate reflector embodiment) relates to an binder layer primarily functioning as an adhesive to adhere adjacent nonwoven sheets together in a face to face orientation, and secondarily functioning to increase the photopic reflectance of the diffuse reflector. Encompassed by this embodiment is an adhesive binder layer adhering a nonwoven sheet to another substrate in a face to face orientation. In the laminate reflector embodiment, nonwoven sheet can have a binder layer on each nonwoven sheet face. A second binder layer embodiment (herein also referred to as the single-sheet reflector embodiment) is a binder layer adhered to one face of a single nonwoven sheet, primarily functioning to increase the photopic reflectance of the diffuse reflector, and optionally secondarily functioning to adhere the diffuse reflector to another substrate in a face to face orientation.

Binder layer generally has a thickness of from about 5 μm to about 100 μm. Binder layer in the laminate reflector embodiment generally has a thickness of from about 10 μm to about 100 μm, sufficient for adhering adjacent nonwoven sheets together in a face to face orientation, or sufficient for adhering a nonwoven sheet and another substrate together in a face to face orientation. Binder layer in the single-sheet reflector embodiment generally has a thickness of from about 5 μm to about 50 μm, preferably about 5 μm to preferably about 25 μm, preferably from about 20 μm to about 30 μm, sufficient to increase the photopic reflectance of the diffuse reflector. If the thickness of the binder layer is too small (e.g., less than about 5 μm), then the contribution to photopic reflectance by the binder layer becomes nonbeneficially low due to the low volume cross section of scatterer in such a thin binder layer.

The aforementioned binder layer thickness values are relevant to binder containing an amount of scatterer as taught herein, and can vary when the amount of scatterer differs from that taught herein. For instance, increasing the amount of scatterer in binder from that taught herein generally increases the binder layer's contribution to the photopic reflectance of the diffuse reflector, but can reduce the adhesive strength and flexibility of the binder layer. Higher amounts of scatterer allow for a relatively thinner reflective binder layer without concomitant reduction of photonic reflectance and find utility in diffuse reflectors comprising a nonwoven sheet having a binder layer on one face (i.e., the single-sheet reflector embodiment). Decreasing the amount of scatterer in binder generally reduces the binder layer's contribution to the photopic reflectance of the diffuse reflector, however will generally increase the adhesive strength and flexibility of the binder layer. Lower amounts of scatterer allow for a relatively thinner adhesive binder layer without concomitant loss of adhesive strength and flexibility of the binder layer and find utility in diffuse reflectors comprising a plurality of nonwoven sheets laminated in a face to face orientation with an adhesive binder layer at each nonwoven sheet interface (i.e., the laminate reflector embodiment).

Adhesion of binder layer to nonwoven sheet needs to be sufficient such that delamination does not occur at the binder layer and nonwoven sheet boundary under diffuse reflector handling and use conditions. Sufficient adhesion exists where the binder layer and nonwoven sheet peel strength is at least about 0.75 pli (pounds per linear inch), preferably at least about 1 pli as measured by ASTM D903, “Test for peel or stripping strength of adhesive bonds.”

The binder layer of diffuse reflectors according to the present invention includes binder. Binder as used herein means a continuous solid phase that functions to maintain scatterer in a dispersed state in close proximity to the nonwoven sheet.

Binder of diffuse reflectors according to the present invention has a low absorption of visible light and preferably does not absorb visible light. By low absorption is meant that binder generally has an absorption coefficient of about 10⁻³ m²/g or less, preferably about 10⁻⁵ m²/g or less, and more preferably about 10⁻⁶ m²/g or less. Binder absorption coefficient greater than about 10⁻³ m²/g results in sufficient absorption of visible light by the binder to cause an undesirable lowering of the photopic reflectance of the diffuse reflector. The influence of binder absorption is greater than the influence of binder refractive index on the photopic reflectance of the diffuse reflector. Thus, it is preferred that binder maintain very low absorption of visible light even after use for an extended period of time (e.g., three years) at optical display device operating temperatures (e.g., about 50 to 70° C., the typical operating temperature range of a direct view backlight cavity).

Binder for diffuse reflectors according to the present invention generally has a coefficient of thermal expansion similar to that of the nonwoven sheet to which it is adhered. Matching the coefficient of thermal expansion assures that the diffuse reflector will suffer minimal to no warping, bending or delamination due to differential thermal expansion between the binder layer and nonwoven sheet.

The thermal stability and UV stability of binder for diffuse reflectors according to the present invention is generally no less than that of the nonwoven sheet.

In applications where the present diffuse reflector is creased or repeatedly bent or flexed during installation or use, binder generally has flexural properties similar to those of the nonwoven sheet. Flexural fatigue can lead to cracks in the binder layer and create regions of minimal or no adhesion between the binder layer and the nonwoven sheet. This can result in unacceptable delamination of the binder layer and nonwoven sheet.

Binder satisfying the aforementioned criteria includes polymers. Polymeric binder includes thermosetting polymers such as polyester, resorcinol and phenolresorcinol formaldehyde, epoxy, polyurethane and arylic. Polymeric binder further includes thermoplastic polymers such as cellulose acetate and cellulose acetate butyrate, polyvinyl acetate, vinyl vinylidene, acrylic, vinyl/acrylic, polyamide, phenoxy and fluoropolymer. Polymeric binder further includes elastomeric polymers such as polyisobutylene, nitrile, styrene butadiene, polysulfide, silicone and neoprene. Polymeric binder further includes hybrid modified polymers such as epoxy-phenolic, epoxy-polysulfide, epoxy-nylon, nitrile-phenolic, neoprene-phenolic, rubber modified epoxy, rubber modified acrylic and epoxy urethane. The glass transition temperature (T_{g}) of polymeric binder is generally in the range of from −75 to 30° C. Polymeric binder having a T_{g} below −75° C. typically has poor cohesive strength. Consequently, the surface of the binder layer can become tacky, causing the binder layer to become soiled or even delaminate from the nonwoven sheet. Polymeric binder having T_{g} exceeding 30° C. typically exhibits brittleness and unacceptable adhesion to the nonwoven sheet, causing the binder layer to be easily cracked or delaminate from the nonwoven sheet when the diffuse reflector is flexed. Preferred polymeric binders include polyurethanes, polyesters such as polyethylene terephthalate and polybutylene terephthalate, polyacrylics such as polymethyl acrylate, polyethyl acrylate and polymethyl methacrylate, and silicones. Binder can contain small amounts, for example less than about 5 weight percent based on the amount of binder, of conventional polymer additives, such as plasticizers, stabilizing agents, deterioration inhibitors, dispersants, antistatic agents, curing agents, leveling agents, ultraviolet absorbers, anti-oxidizing agents, viscosity modifying agents, lubricants, light stabilizers and the like.

The binder layer for diffuse reflectors according to the present invention includes scatterer that functions to scatter visible light. Scatterer is in a dispersed state throughout the binder. Generally, each scatterer is surrounded by binder and not in physical contact with other scatterers. Example scatterers include particles (herein alternately referred to as particulate scatterer) and voids.

The light scattering cross section per unit scatterer volume of binder containing dispersed scatterer depends strongly on the difference between the refractive index of the scatterer and the binder. A larger light scattering cross section is preferred and can be obtained by maximizing the difference between the refractive index of the scatterer and the binder. The difference between the refractive index of the scatterer and the binder is generally at least about 0.5, preferably at least about 1.

The refractive index of particulate scatterer of utility in the present diffuse reflector is generally at least about 1.5. High refractive index particulate scatterer generally has a refractive index of at least about 2.0, preferably at least about 2.5. Particulate scatterer having a refractive index less than that of the high refractive index particulate scatterer may be referred to herein as low or lower refractive index particulate scatterer. Void scatterers have a refractive index of 1.0, which is the refractive index of air contained within the voids.

In one embodiment of binder layer comprising a binder and a scatterer of visible light dispersed in the binder, high refractive index particulate scatterer is present in the binder in an amount below the critical particle volume concentration (herein alternately referred to as CPVC), such that the binder layer is substantially free of voids. In another embodiment, high refractive index particulate scatterer is present in the binder in an amount greater than the CPVC, such that the binder layer contains voids. In another embodiment, low refractive index particulate scatterer is present in the binder in an amount greater than the CPVC, such that the binder layer contains voids. In another embodiment, a mixture of high refractive index particulate scatterer and low refractive index particulate scatterer is present in the binder in an amount either above or below the CPVC, such that the binder layer is either substantially free of, or contains, voids.

Scatterer shape is not particularly limited, and may be for example, spherical, cubic, aciculate, spindle, discal, scale-like, fibrous and the like. While such shapes can be useful for creating voids, spherical shape is preferred for high refractive index particulate scatterer.

Scatterer can be solid or hollow. Voids can arise from the use of hollow particles (i.e., having internal voids), such as hollow sphere plastic particles.

Voids for scattering light of utility as scatterer in the present diffuse reflectors can be created in the binder layer by particle packing at relatively high particle volume concentrations. Particle volume concentration (herein alternately referred to as PVC) is the volume of particles as a percentage of the volume of all solid components comprising the binder layer. For example, in a binder layer containing particles and binder, PVC(%)=100×(volume particles)/(volume particles+volume binder). At the CPVC, there is just enough binder to fill the intersticial space between particles. Particles contained in the binder layer in a PVC greater than the CPVC results in scatterer additionally comprising voids containing air. The voids are located in the intersticial space between particles. Particle size and shape are two factors controlling the size and total volume of the voids. Particles present in the binder layer in an amount greater than the CPVC and having a mean diameter of from about 0.2 μm to about 5 μm will pack in a manner that results in voids of optimal dimension for light scattering. The visible light scattering cross section per unit void volume is maximized for voids having mean void diameters slightly less than one-half the wavelength of visible light. Voids of high light scattering efficiency of utility as scatterer have a mean diameter of from about 0.01 μm to about 1 μm, preferably from about 0.05 μm to about 0.5 μm, as measured by the mercury porosimetry methodology as disclosed by H. M. Rootare in “A Review of Mercury Porosimetry” from Advanced Experimental Techniques in Powder Metallurgy, pp. 225-252, Plenum Press, 1970.

Particles having low absorption of visible light that function to scatter visible light are of utility as scatterer in the present diffuse reflectors. Particles include those conventionally known as white pigments. If the refractive index of the particles is substantially the same as the refractive index of the binder (e.g., low refractive index particulate scatterer where the refractive index difference between the binder and scatterer is less than about 0.5), then such particles will generally not function as scatterer at concentrations below their CPVC in the present diffuse reflectors. However, such particles are of utility for creating light scattering voids when included in the binder in an amount above the CPVC. High refractive index particulate scatterer, for example titanium dioxide, is highly effective in scattering light even in the substantial absence of voids when used in the binder in an amount below the CPVC. High refractive index particulate scatterer can also be used in the binder in an amount above the CPVC, and in such an embodiment also results in the formation of light scattering voids.

The light scattering cross section per unit scatterer volume of binder containing closely spaced scatterer is maximized when the mean diameter of the scatterer is slightly less than one-half the wavelength of the incident light. The diameter of particles of utility as scatterer in the present diffuse reflectors can be measured by conventional sedimentation or light scattering methodology. For high refractive index particulate scatterer, the particle mean diameter is generally from about 0.1 μm to about 30 μm, preferably about 0.2 μm to about 1 μm. If high refractive index particulate scatterer is used, then the diffuse reflectance of the present diffuse reflector is maximized when the particles have a mean diameter of from about 0.2 μm to about 0.4 μm, slightly less than one-half the wavelength of the incident light. If the scatterer mean diameter is outside of the aforementioned range, then the contribution by the binder layer to the photopic reflectance of the diffuse reflector is reduced from that possible with scatterers of mean diameter within the aforementioned range. Further, if scatterer mean diameter is above about 30 μm, then uniform dispersion of scatterer in binder can become difficult, and result in an undesirably rough binder layer surface which can contribute to failure of the binder layer.

Particulate scatterer of utility in the present diffuse reflectors has low absorption of visible light. By low absorption is meant that scatterer generally has lower absorption than binder or does not substantially contribute to the absorption of the binder layer. The present binder layer comprising binder and scatterer generally has an absorption coefficient of about 10⁻³ m²/g or less preferably about 10⁻⁵ m²/g or less. In the embodiment where scatterer comprises titanium dioxide, the absorption coefficient of the binder layer comprising binder and scatterer is about 10⁻³ m²/g or less preferably about 10⁻⁵ m²/g or less at wavelengths from about 425 nm to about 780 nm.

The composition of particles of utility as scatterer in diffuse reflectors according to the present invention is not particularly limited, and includes metal salts, metal hydroxides and metal oxides. For example: metal salts such as barium sulfate, calcium sulfate, magnesium sulfate, aluminum sulfate, barium carbonate, calcium carbonate, magnesium chloride, magnesium carbonate; metal hydroxides such as magnesium hydroxide, aluminum hydroxide and calcium hydroxide; and metal oxides such as calcium oxide, magnesium oxide, alumina and silica. Additionally, clays such as kaolin, alumina silicates, calcium silicate, cements, zeolites and talc are also of utility. Plastic pigments are also of utility. High refractive index particulate scatterer comprising white pigment particles are preferred and include for example titanium dioxide and zinc oxide. Titanium dioxide has the highest light scattering cross section per unit volume as well as low absorption of visible light and is most preferred as scatterer.

The amount of scatterer dispersed in the binder directly impacts the binder layer contribution to the photopic reflectance of the diffuse reflector. If the amount of scatterer in the binder is too small, then the binder layer does not substantially contribute to the photopic reflectance of the diffuse reflector. If the amount of scatterer in the binder is too large, then the adhesive properties of the binder layer can be adversely affected and the binder layer can become difficult to uniformly coat on the nonwoven sheet. In an embodiment where scatterer includes voids of the aforespecified mean diameter, the porosity of the binder layer is generally desired to be about 55% or less, preferably in the range of from about 20% to about 55%. Porosity (%) (C) is herein defined as the volume of voids as a percentage of the total binder layer volume and is calculated in accordance with the formula C(%)=(1-B/A)100, wherein A is the specific gravity of the solid phase binder comprising the binder layer, and B is the bulk density of that binder layer including the voids. Porosity can be attributed to the packing of particles at concentrations above CPVC. In the embodiment where scatterer includes voids, if the binder layer porosity is less than 20%, then interfaces between closely spaced refractive index inhomogeneities decrease, and the binder layer contribution to the photopic reflectance of the diffuse reflector decreases. The upper limit of the porosity of the binder layer is generally about 55%, when considering the coatability, adhesion and structural integrity of the binder layer.

In an embodiment where scatterer comprises high refractive index particulate scatterer within the aforespecified mean diameter range, scatterer concentration at, above or below the CPVC is of utility. In one embodiment, the volume of the high refractive index particle in the binder is below the CPVC. When the total PVC (volume of higher refractive index particles plus volume of other particles) is above the CPVC, air void scattering sites will also be present. Thus, in another embodiment to achieve maximal light scattering from a binder layer, both a high concentration of high refractive index particulate scatterer and high porosity are utilized. In this embodiment, the volume of the high refractive index particle in the binder is above the CPVC.

Nonwoven sheet diffuse reflectors of the present invention can further comprise ultraviolet (UV) stabilizer, which is a substance coating, or more preferably, dispersed throughout the polymer phase of the nonwoven sheet fibers to prevent photo deterioration by UV light. Additionally, the present binder layer may contain UV stabilizer. UV stabilizers work by absorbing UV radiation and prevent the formation of free radicals in the fiber polymer and polymer binder backbones, which can lead to undesirable chain fragmentation and degradation of nonwoven sheet and binder layer optical properties. Beneficial concentrations of UV stabilizer are from about 0.01 weight % to about 5.0 weight %, based on the weight of the nonwoven sheet polymer or binder. Conventional UV stabilizers of known utility in plastics may be used, for example those from the groups benzophenones, hindered tertiary amines, benzotriazoles and hydroxyphenyl triazines. Commercial UV stabilizers of utility include the CHIMASSORB® and TINUVIN® families of stabilizers sold by Ciba Specialty Chemicals, Tarrytown, N.Y., USA.

Binder has a tendency to undesirably yellow with age. One way to mitigate the yellowing of binder is to apply the binder layer in a thinner coating. However, this can result in reduced strength of the laminate bond. Binder containing scatterer can be applied to a nonwoven sheet in a discontinuous or patterned (e.g., square grid) coating so that a relatively smaller fraction of the nonwoven sheet face surface area is coated. This allows for the overall amount of binder to be reduced while keeping the thickness of the applied binder layer high allowing higher laminate bond strength. A second method of mitigating the yellowing of the binder layer is to formulate the binder layer to contain conventional ultraviolet (UV) screening additives and/or UV stabilizers, such as those disclosed earlier herein.

Diffuse reflectors according to the present invention can comprise single or multiple layers of nonwoven sheets, such as laminates of two or more nonwoven sheets. This laminate reflector embodiment is particularly useful in obtaining diffuse reflectors having high photopic reflectance, for example, photopic reflectance of about 98% over the visible wavelength range. The laminate reflector embodiment is also useful for averaging out nonuniformities in single nonwoven sheets due to nonuniform sheet thickness or directionality of sheet fibers. Laminates of nonwoven sheets are prepared by adhering two or more sheets together with a binder layer as defined herein.

Thus, included in the present invention are diffuse reflectors comprising a nonwoven sheet laminate. Laminates include two nonwoven sheets with binder layer at the nonwoven sheet interface, the laminate having a total thickness of less than about 400 μm and a photopic reflectance by the spectrophotometer method over the wavelength range of visible light of at least about 96%. Laminates include three nonwoven sheets with binder layer at each nonwoven sheet interface, the laminate having a total thickness of less than about 600 μm and a photopic reflectance by the spectrophotometer method over the wavelength range of visible light of at least about 97%. Laminates include four nonwoven sheets with binder layer at each nonwoven sheet interface, the laminate having a total thickness of less than about 900 μm and a photopic reflectance by the spectrophotometer method over the wavelength range of visible light of at least about 98%.

Diffuse reflectors according to the present invention can further comprise backing support sheet to add stiffness to, and maintain the shape of, the diffuse reflector during diffuse reflective article assembly and use. Such backing support sheet is positioned on the face of the diffuse reflector facing away from the light source. Backing support sheet materials of utility include polyester films (e.g., Mylar®, white PET), aramid fiber (e.g., KEVLAR®), both available from E. I. du Pont de Nemours & Co., Wilmington, Del., USA, as well as paper, fabric or wovens, nonwoven sheets, foamed polymer, polymer films, metal foil or sheet and metallized film. Backing support sheet can be selected so as to increase the total reflectance of the diffuse reflector (e.g., backing support sheet comprising metal foil or sheet and metallized film). Backing support sheet and diffuse reflector may be laminated to one another with the present binder layer or conventional pressure-sensitive adhesives by conventional techniques. In addition, to create diffuse reflectors of complex shapes, diffuse reflectors of the present invention can be bonded to a rigid support material and then formed as a composite into shapes, such as parabolic or ellipsoidal domes.

Diffuse reflectors or the present invention can further comprise a specular reflective layer positioned on the face of the nonwoven sheet facing away from the light source. Positioning a specular reflector as such increases the photopic reflectance of the diffuse reflector. In one embodiment, the binder layer face of a nonwoven sheet containing a binder layer on one face can be metallized. Representative metals include aluminum, tin, nickel, iron, chromium, copper, silver or alloys thereof, with aluminum preferred. Metals can be deposited by known vacuum metallization techniques in which metal is vaporized by heat under vacuum, and then deposited on the binder layer face in a thickness from about 75 angstroms to about 300 angstroms. Vacuum metallization is known, for example in U.S. Pat. No. 4,999,222. In this embodiment, a thin specular reflecting layer is added to the binder layer face of the diffuse reflector without substantially changing the overall thickness of the reflector. In another embodiment, the specular reflective layer comprises a metallized polymer sheet, for example aluminized MYLAR®, which can be laminated to a diffuse reflector, with a metallized face of the metallized polymer sheet facing the binder layer face of a nonwoven sheet containing a binder layer on one face. In another embodiment, the specular reflective layer comprises a metal foil, for example aluminum foil, which can be laminated to the binder layer face of a nonwoven sheet containing a binder layer on one face, resulting in a stiffened diffuse reflector. Aluminum has a lower coefficient of thermal expansion than nonwovens, and is an extremely good thermal conductor. Both factors lead to minimization of temperature variations and therefore reduce the tendency for a present diffuse reflector to buckle under uneven heating encountered in LCDs with light sources comprising banks of tubular lights. The diffuse reflectors of this embodiment can be formed by laminating a metal foil to the binder layer face of a nonwoven sheet containing a binder layer on one face by using the binder layer as adhesive or by using conventional pressure sensitive adhesives. In these embodiments where a diffuse reflector contains a metallized face or is laminated to a metallized polymer sheet or metal foil, the remaining (metal-free) nonwoven face of the diffuse reflector is positioned in the optical cavity facing the light source.

Diffusivity of reflected light is important to establishing luminance uniformity of LCD backlights. Line light sources such as cold-cathode fluorescent lamps (CCFLs) and point light sources such as red, green and blue light emitting diodes (RGB LEDs) are inherently not diffusive light sources. High diffusivity reflectors are desirable in direct-view backlights because their wider scattering angle leads to better luminance uniformity. Higher diffusivity is more critical for backlights where the CCFLs are more widely spaced apart and in backlights where a non-uniform color in the backlight needs to be addressed, such as backlights with RGB LED light sources. Further, many commercial backlight reflectors have a decreased blue reflectance which forces backlight manufacturers to consider methods to improve blue emission including fluorescent additives, higher blue emission (LED) and increased blue phosphor in the CCFL design. Such solutions have an associated drawback including reflectance stability (fluorescent additives) and decreased lifetime (increases blue LED and increased blue CCFL phosphor).

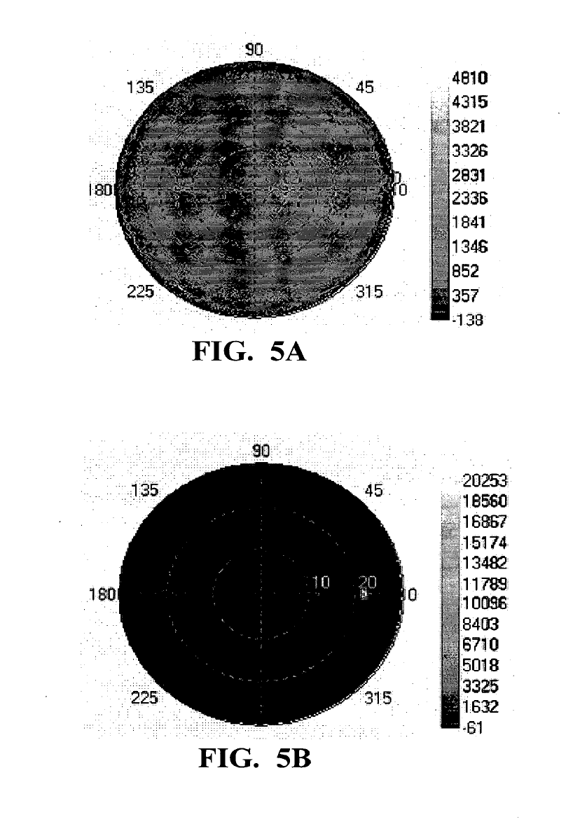

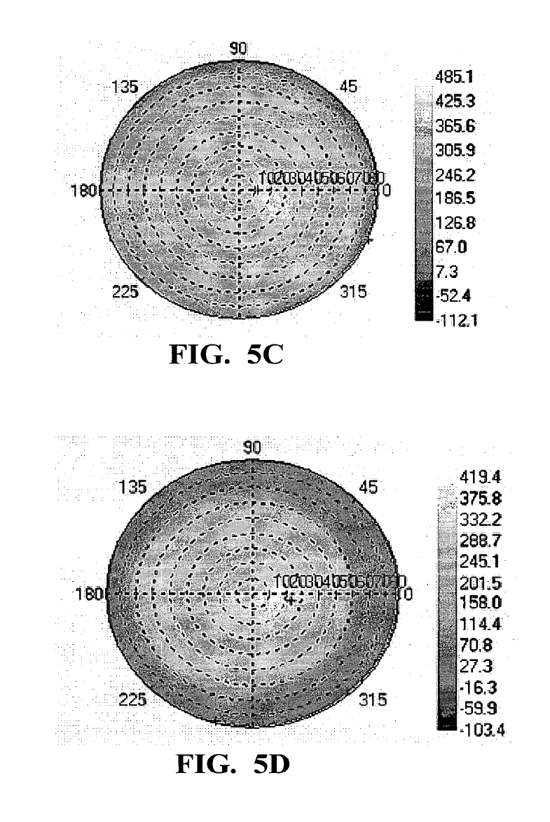

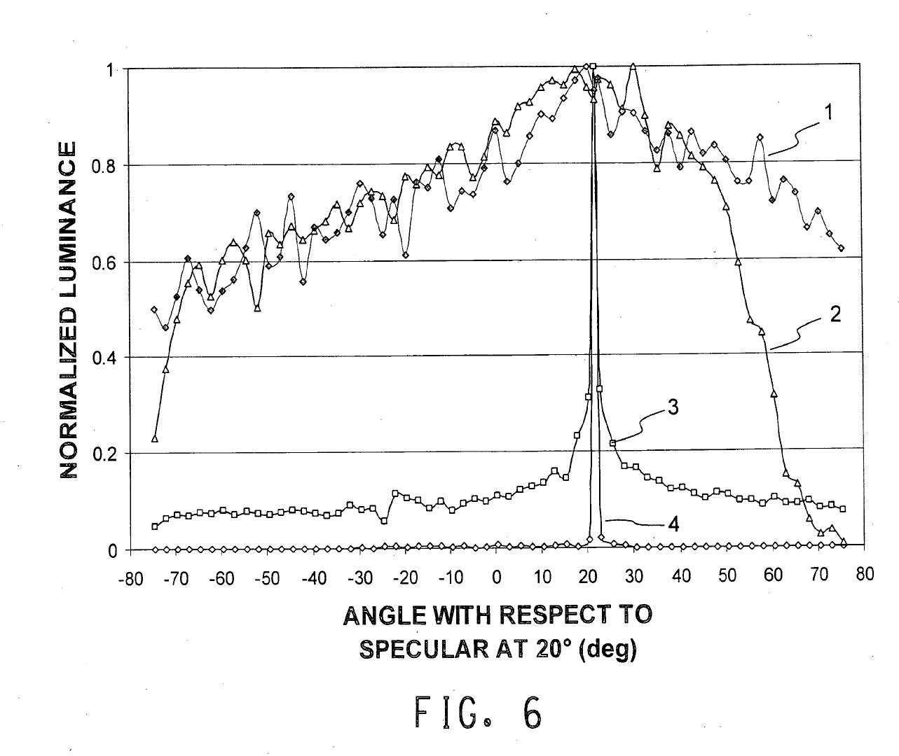

The present diffuse reflectors have highly diffuse reflectance. Typically, this corresponds to an average estimated angular bandwidth (ABW) at 50% of peak luminance of at least about 120 degrees. This is illustrated in Example 5 and FIGS. 5 and 6, which show that the diffuse reflectance of the present reflectors is higher than is available from commercial backlight reflectors. The wider diffusion cone exhibited by the present diffuse reflectors results in a wider scattering angle and therefore improved optical display uniformity. Higher diffuse reflectivity allows thinner backlight designs by using the wider diffusion cone to more effectively scatter light at high angles throughout the backlight unit. This characteristic of the present diffuse reflectors allows for the use of more transmissive diffuser plates resulting in higher utilization of light from the light source.

The present diffuse reflectors can be manufactured by a method comprising the steps of: preparing a mixture comprising binder, scatterer and optionally diluent, coating the mixture onto at least one face of a nonwoven sheet, and optionally curing the mixture to form the binder layer.

Mixtures comprising binder and scatterer can be prepared by weighing and combining the appropriate amounts of each (e.g., as a finely divided powder, pellets, solution, dispersion or other state), and mixing using conventional apparatus (e.g., with a Banbury mixer).

Coating of the binder and scatterer mixture onto at least one face of a nonwoven sheet can be carried out by various known methods. For example, application methods such as the bar coating method, roll coating method, spray coating method and dip coating method, entire surface printing methods such as silkscreen printing, offset printing, gravure printing and flexographic printing, and molding methods such as extrusion molding method.

The optional curing step involves curing the mixture to form the binder layer. This step is necessary when the binder and scatterer composition contains a solvent (e.g., such as when polymer binder comprises an acrylic latex) and is carried out by allowing the coated nonwoven sheet to rest an appropriate amount of time under ambient or other conditions (e.g., elevated temperature, decreased pressure, etc.) until the solvent has evaporated from the composition leaving the binder layer deposited on the nonwoven sheet.

The present invention further relates to a diffuse reflective article comprising a diffuse reflector of visible light and a structure forming an optical cavity, wherein the diffuse reflector has a nonwoven face and is positioned within the optical cavity such that light reflects off of the nonwoven face and out of the optical cavity toward an object benefiting from illumination, and wherein the diffuse reflector comprises a nonwoven sheet having on one face thereof a binder layer comprising a binder and a scatterer of visible light dispersed in the binder. In one embodiment, the article further comprises a light source positioned within the optical cavity so that light from the light source directed toward the interior of the optical cavity reflects off of the nonwoven face of the diffuse reflector and out of the optical cavity toward an object benefiting from illumination. In one embodiment, the article further comprises a display panel through which passes light reflected from the nonwoven face of the diffuse reflector. In one embodiment, the article further comprises a light source positioned within the optical cavity and a display panel through which light from the light source passes, wherein the diffuse reflector is positioned within the optical cavity for reflecting light from the light source off of the nonwoven face of the diffuse reflector and toward the display panel.

The present invention further relates to an optical display, comprising: (i) a structure defining an optical cavity; (ii) a light source positioned within the optical cavity; (iii) a display panel through which light from the light source passes; and (iv) a diffuse reflector comprising a nonwoven sheet having on one face thereof a binder layer comprising a binder and a scatterer of visible light dispersed in the binder, the diffuse reflector positioned within the optical cavity to reflect light from the light source off of the nonwoven face of the diffuse reflector toward the display panel.

The present diffuse reflective article or optical display comprises a diffuse reflector of light positioned within a structure defining an optical cavity. “Optical cavity” refers herein to an enclosure designed to receive light from a light source, and condition and direct such light toward an object benefiting from illumination. Optical cavities include structures for integrating, redirecting and/or focusing light from a source onto a receiver and may use air or high refractive index elements as the cavity medium. The geometrical shape of the structure is not limited. Example structures containing optical cavities include luminaires, copying machines, projection display light engines, integrating sphere uniform light sources, sign cabinets, light conduits and backlight assemblies. In certain embodiments, such as backlight units for liquid crystal displays (LCDs), the optical cavity may include a lightguide or waveguide. Where the diffuse reflective article is a component of an optical display, optical cavity refers to an enclosure designed to contain a light source and direct the light from the light source toward a display panel. Display panels include static and dynamic (addressable) display types.

The present diffuse reflective article optionally contains, and the present optical display contains, a light source positioned within the optical cavity. “Light source” refers herein to emitters of visible light and can be a single light source within an optical cavity or multiple light sources within an optical cavity. Example light sources include bulb and tube lamps of type incandescent, mercury, metal halide, low pressure sodium, high pressure sodium, arc, compact fluorescent, self ballasted fluorescent, cold cathode fluorescent lamp (CCFL), light emitting diode (LED) and similar apparatus capable of emitting visible light.

The present diffuse reflective article optionally contains, and the present optical display contains, a display panel through which light from the light source passes. “Display panel” refers herein to transmissive devices that modulate the transmission of light from the light source, and in certain embodiments, modulate the light for the purpose of conveying an image in the form of visible light to a viewer. In the embodiment where the structure defining the optical cavity is a sign cabinet system for the purpose of conveying a static image to a viewer, example display panels include polymer or glass panels with a static image contained thereon (e.g., a text or pictorial image). In the embodiment where the structure defining the optical cavity is a luminaire for the purpose of directing light to a space or object benefiting from illumination, example display panels include solid, louvered and gridded panels of materials such as polymer, glass or metal of conventional utility as fittings for luminaires (e.g., fluorescent light diffusers). In the embodiment where the structure defining an optical cavity is a backlight unit for a liquid crystal display for the purpose of conveying static and/or changing images to a viewer, an example display panel includes a liquid crystal with an image which changes in response to an electronic signal.

The present diffuse reflective article or optical display contains a diffuse reflector positioned within the optical cavity for reflecting light toward an object benefiting from illumination. The diffuse reflector is positioned within the optical cavity so that it reflects back toward the object light within the optical cavity which is not directed toward the object. The diffuse reflector is positioned within the optical cavity so that it reflects light off of the nonwoven face of the diffuse reflector toward the object benefiting from illumination. In an optical display, the diffuse reflector is positioned behind the optical display light source illuminating the display panel. The light scattering and diffuse reflection characteristics of diffuse reflectors according to the present invention provides more overall diffuse lighting, e.g., a more overall diffuse light source and therefore a more evenly lit or uniformly illuminated optical display.

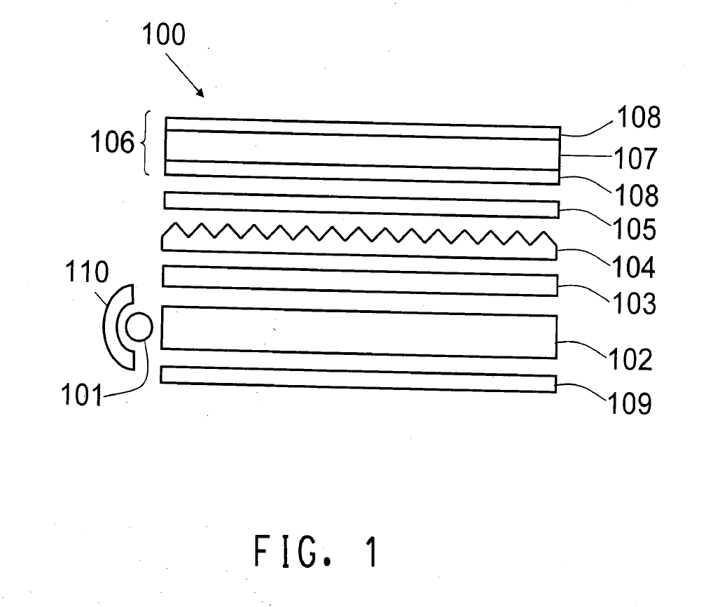

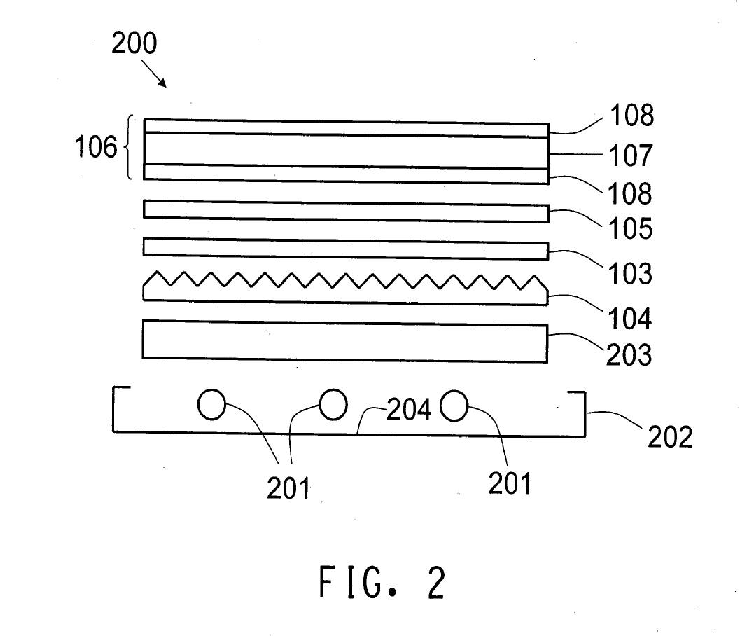

Schematic figures of two embodiments of optical displays utilizing diffuse reflectors according to the present invention are shown in FIGS. 1 and 2.

FIG. 1 includes as illustration a cross-sectional view of an edge-lit liquid crystal optical display utilizing a diffuse reflector according to the present invention. In FIG. 1, an optical display 100 is shown having a fluorescent light source 101 coupled to an optical cavity containing a plastic light guide 102. A diffuser sheet 103, a brightness enhancing film 104, such as those described in U.S. Pat. No. 4,906,070, and a reflective polarizer film 105, such as those described in PCT publication WO 97/32224, are placed on top of the guide 102 and act to redirect and reflectively polarize the light emitted from the guide 102 toward a liquid crystal display panel 106 and a viewer. A liquid crystal display panel 106 is placed on top of the reflective polarizing film 105 and is typically constructed of a liquid crystal 107 contained between two polarizers 108.

The light guide 102 directs light towards the display panel 106 and ultimately a viewer. Some light is reflected from the back surface of the light guide 102. A diffuse reflector 109 according to the present invention is placed behind the light guide 102 with a nonwoven face of the diffuse reflector 109 facing the light guide 102. The diffuse reflector 109 reflects light towards the liquid crystal display panel 106. It also reflects and randomizes the polarization of the light reflected from the reflective polarizing film 105 and brightness enhancing film 104 layers. The diffuse reflector 109 is a highly reflective, high diffusivity surface that enhances the optical efficiency of the optical cavity. The diffuse reflector 109 scatters and reflects light diffusely, depolarizes the light, and has high reflectance over the visible wavelength range.

The diffuse reflector 109 is an element of a light recycling system. The diffuse reflector (i) reflects light rejected from the reflective polarizing film 105 and/or from the brightness enhancement film 104, and (ii) gives that light another opportunity to reach the liquid crystal display panel 106 and ultimately a viewer. This rejecting and recycling can occur numerous times increasing the luminance of the optical display (i.e., the amount of light directed towards the viewer).

This increased optical efficiency of the diffuse reflector can be used to reflect incident light between layer 104 and the diffuse reflector 109 to increase display luminance by controlling the angles over which light is emitted. For instance, brightness enhancing film 104 transmits light within a specific, and narrow angular range and reflects light over another, specific and wider angular range. The reflected light is scattered by the diffuse reflector 109 into all angles. The light within the transmission angles of the brightness enhancing layer 104 is transmitted towards the viewer. Light in the second angular range is reflected by layer 104 for additional scattering by the diffuse reflector 109.

The increased optical efficiency of the diffuse reflector 109 can be used to reflect incident light between the reflective polarizer film 105 and the diffuse reflector 109 to increase display luminance by controlling the polarization state of the light transmitted through the reflective polarizer film 105. Most displays have an absorbing polarizer 108 applied to the back of the display panel 107. At least one half of the available light is absorbed when the display is illuminated by unpolarized light. As a result, display luminance is decreased and the display polarizer 108 is heated. Both adverse situations are overcome with the use of a reflective polarizer film 105, because the reflective polarizer film 105 transmits light of one linear polarization state and reflects the other linear polarization state. If the transmission axis of the reflective polarizer film 105 is aligned with the absorbing polarizer transmission axis, the transmitted light is only weakly absorbed by the absorbing polarizer. Also, the light in the reflected polarization state is not absorbed at all by the absorbing polarizer. Instead, it is reflected towards the diffuse reflector 109. The diffuse reflector 109 depolarizes the light, creating a polarization state that has equal polarization components in the reflective polarizer film transmission and reflection states. One half of the light transmits through the reflective polarizer layer 105 towards the viewer. Light in the reflected polarization state, or “undesirable” state, is again scattered by the diffuse reflector 109, providing yet another chance for additional polarization conversion.

Additionally, a diffuse reflector 110 according to the present invention may be placed behind or around the light source 101, such as a cold cathode fluorescent lamp (CCFL) to increase light coupling efficiency into the plastic light guide 102. The diffuse reflector 110 may be used alone, or in combination with a specular reflector to increase the total reflectance of the construction. When such a specular reflector is used, it is positioned behind the diffuse reflector 110 such that the diffuse reflector remains facing the light source 101.

The increased optical efficiency of the diffuse reflector according to the present invention can be used to increase the reflective efficiency of an optical cavity and/or to mix discrete wavelengths of light to make a uniform colored or white light source. FIG. 2 includes as illustration a cross-sectional view of a backlit liquid crystal optical display with a cold cathode fluorescent lamp light source utilizing a diffuse reflector according to the present invention and further utilizing a diffuser plate 203. In the optical display 200 shown in FIG. 2, three fluorescent lamps 201 are depicted in an optical cavity 202. All of the lamps may be white or each lamp may be a selected color, such as red, green and blue. In an alternate embodiment of FIG. 2, one or more light emitting diodes, colored or white, are utilized instead of fluorescent lamps. In both embodiments of FIG. 2, the optical cavity 202 is lined with a diffuse reflector 204 according to the present invention. Diffuse reflector 204 both increases reflectance and mixes the discrete light colors adequately to form a white light source with good spatial light emitting uniformity for illumination of the liquid crystal display panel 106.

The present invention further relates to a method of improving light reflectivity in a device requiring diffuse reflectivity of light comprising: (i) providing a diffuse reflector comprising a nonwoven sheet having on at least one face thereof a binder layer comprising a binder and a scatterer of visible light dispersed in said binder; and (ii) positioning the diffuse reflector within the device to cause light energy to reflect off of the nonwoven face of the diffuse reflector.

### EXAMPLES

### Basis Weight

Basis weight is measured by the method of ASTM D 3776, modified for specimen size, and is reported in units of g/m².

### Mercury Porosimetry

Nonwoven sheet pore size distribution data are obtained by known mercury porosimetry methodology as disclosed by H. M. Rootare in “A Review of Mercury Porosimetry” from Advanced Experimental Techniques in Powder Metallurgy, pp. 225-252, Plenum Press, 1970. “VP1” as hereinbefore defined is the volume of nonwoven sheet pores as measured by mercury porosimetry having a mean pore diameter of from 0.01 μm to 1.0 μm. “VP2” as hereinbefore defined is the volume of nonwoven sheet pores as measured by mercury porosimetry having a mean pore diameter of from 0.02 μm to 0.5 μm.

### Specific Pore Volume

Specific pore volume (in units of cm³/m², also referred to herein as “SPV”) as hereinbefore defined is the mathematical product of the nonwoven sheet basis weight (in units of g/m²) and the sheet pore volume (in units of cm³/g) for pores of a given mean pore diameter range. SPV1 as hereinbefore defined is the specific pore volume relating to the VP1 mean pore diameter. SPV2 as hereinbefore defined is the specific pore volume relating to the VP2 mean pore diameter.

### Thickness

Thickness measurements are made with an Ono Sokki EG-225 thickness gauge with a 0.95 cm (⅜ inch) measurement probe affixed to a Ono Sokki ST-022 ceramic base gauge stand, both available from Ono Sokki, Addison, Ill., USA.

### Delamination

Delamination values for bonded nonwoven sheets are obtained by the method of ASTM D2724, and reported in units of kg/m.

### Reflectance Spectra—Spectrophotometer Method

Unless otherwise stated, total reflectance spectra are obtained by the method of ASTM E1164-02 (Standard Practice for Obtaining Spectrophotometric Data for Object-Color Evaluation). A diffuse reflector or other sheet is placed in a Lambda 650 UV/VIS/NIR Spectrometer with a 150 mm integrating sphere attachment, both available from PerkinElmer, Wellesley, Mass., USA. Diffuse reflectors of the present invention are placed in the spectrometer with the nonwoven face of the diffuse reflector facing the spectrometer light source. The output is a percent reflectance at each wavelength and the spectral range measured is 380 nm to 780 nm in 5 nm intervals. The reflectance standard is a calibrated SPECTRALON® standard purchased from LabSphere, North Sutton, N.H., USA. Photomultiplier detection is used. Tristimulus values are calculated by the method of ASTM E308-01 using the CIE 10° 1964 standard observer and illuminant D65. The photopic reflectance, R_{VIS}, is calculated using illuminant D65 and the CIE Standard Photopic observer described in “Billmeyer and Saltzman Principles of Color Technology”, 3^{rd} Edition.

### Nonwoven Sheet Utilized in Examples 1, 2 and 3

Described here is the nonwoven sheet used to form the EX. 1, EX. 2 and EX. 3 diffuse reflectors. The nonwoven sheet is a single sheet of flash-spun high density polyethylene (HDPE) comprising a plurality of plexifilamentary film-fibrils of HDPE. The EX. 1 and EX. 2 nonwoven sheet is free from particulate filler and is produced by the general process disclosed in U.S. Pat. Nos. 3,081,519, 3,227,794 and 3,860,369. The EX. 3 nonwoven sheet contains titanium dioxide particulate filler dispersed in the polymer phase forming the nonwoven sheet fibers, and is produced by the general process disclosed in U.S. Pat. No. 6,010,970 or PCT publication number WO2005/98,119.

This general process for producing the nonwoven sheet can be summarized as three steps. Step one is spinning. A solution of high density polyethylene (HDPE) with either CFC-11 (fluorotrichloromethane) or C-5 hydrocarbons is subjected to two pressure reductions. The first results in a two-phase liquid solution. The second, to atmospheric pressure, results in the flash evaporation of the non-polymer component leaving an interconnected web of solid HDPE. In the case of the EX. 3 nonwoven sheet, the solution of HDPE further contains suspended Ti-Pure® R-101 titanium dioxide particles, available from DuPont Titanium Technologies, USA, such that the resulting nonwoven sheet has about 10 weight percent of Ti-Pure® R-101 titanium dioxide particles dispersed in the polymer phase forming the nonwoven sheet fibers. A series of webs are collected on a paper machine and wound into rolls.

Step two is thermal area bonding. The rolled webs are unwound and each web surface is brought into contact with a steam heated drum. The temperature of the heated drum is 135-140° C., and the melting temperature of the HDPE from which the web is made is 135-138° C. The contact time between the heated drum and the web is brief, with the result that only the surface fibrils of the web reach a temperature close to the melting temperature of the HDPE, as indicated by the fibrils only at the surface of the resultant nonwoven sheet adhering together at contact points between intersecting fibrils. To prevent the nonwoven sheet from shrinking excessively, a blanket holds the nonwoven sheet against the drum surface effectively restraining it. Each nonwoven sheet surface is cooled by contact with a chilled drum immediately after leaving the steam heated drum. After thermal area bonding, the nonwoven sheet can optionally be corona treated on one or both sides and optionally have antistat agent applied to one or both sides. The product is then wound into rolls.

Step three is the slitting step. The product is slit to a desired width and wound into rolls of a desired length.

Multiple (i.e., at least twelve) 34 mm×34 mm square nonwoven sheet samples are cut from different areas of a continuous nonwoven sheet. The thickness of each nonwoven sheet sample is measured by the aforementioned Thickness method and averaged by the number of nonwoven sheet samples to determine an average thickness of about 185 μm for the EX. 1 and EX. 2 nonwoven sheet, and an average thickness of about 230 μm for the EX. 3 nonwoven sheet. Basis weight of each nonwoven sheet sample is determined by the aforementioned Basis Weight method and averaged by the number of nonwoven sheet samples to determine an average basis weight of 70 g/m² for the EX. 1 and EX. 2 nonwoven sheet, and 68 g/m² for the EX. 3 nonwoven sheet. A total reflectance spectrum is obtained for each nonwoven sheet sample by the aforementioned Spectrophotometer method and the R_{VIS} value calculated. The nonwoven sheet sample spectra are averaged to determine an average reflectance spectrum and R_{VIS} of 94.0% for the EX. 1 and EX. 2 nonwoven sheet. The EX. 3 nonwoven sheet has a reflectance at 550 nm of about 97.3% and color b* of about 0.5, as measured by the procedure of ASTM E 1164 (400 to 700 nm in 10 nm increments) using an X-Rite SP64 spectrophotometer and D65/10 illuminant/observer. The delamination value for the nonwoven sheet is measured by the aforementioned Delamination method to be 5.2 kg/m for the EX. 1, EX. 2 and EX. 3 nonwoven sheet. VP1 and VP2 of the nonwoven sheet are determined by the aforementioned Mercury Porosimetry method to be 0.55 cm³/g (VP1) and 0.41 cm³/g (VP2) for the EX. 1 and EX. 2 nonwoven sheet. Specific pore volumes SPV1 and SPV2 are calculated as previously described to be 39 cm³/m² (SPV1) and 29 cm³/m² (SPV2) for the EX. 1 and EX. 2 nonwoven sheet.

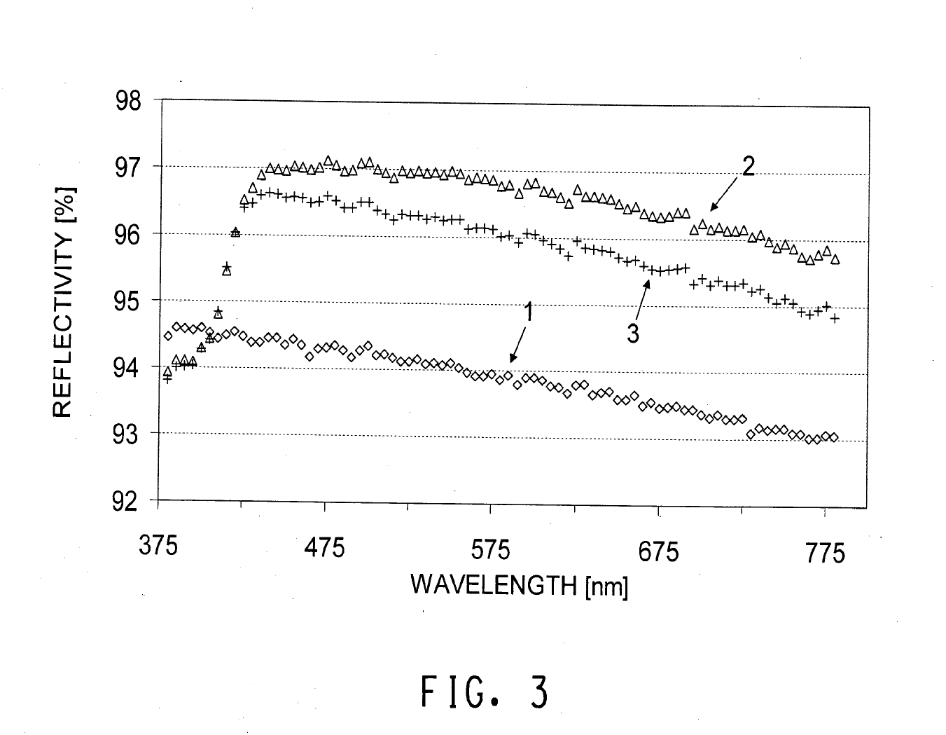

The line labeled 1 in FIG. 3 is a graph of the total reflectance spectrum (reflectivity (%) versus wavelength (nm)) for the nonwoven sheet utilized in the EX. 1 and EX. 2 diffuse reflectors.

### Example 1

### Diffuse Reflector

The slot die coating head method is used to prepare a diffuse reflector comprising a nonwoven sheet having on one face a binder layer comprising a binder and a scatterer of visible light dispersed in the binder. Slot die coating is used due to the ability to directly meter a coating avoiding recirculating flow of excess material, the ability to handle high viscosity liquids, provide uniformity in both transverse and machine direction as well as minimize premature or localized drying which can create streaks, debris and related coating disturbances.

A 35.6 cm (14 in) wide roll of the previously described nonwoven sheet is unwound at a line speed of 152.4 cm/min (5 ft/min) and passed over a solid support backup roll. The binder containing scatterer used is Behr Premium Plus® Exterior Semi-Gloss Ultra Pure White No. 5050, available from BEHR Process Corporation, CA, USA, a white acrylic latex paint having 49% solids by weight, a density of 1.25 g/cm³, and viscosity of 13,000 cps. A coating of this paint is directly metered on to the moving nonwoven sheet surface at a rate of 77 cm³/min at a width of 33.0 cm (13 in) and wet thickness of about 153 μm.

The height and width of the slot is set by a precise thickness of metal shim stock that separates the die halves when bolted together. The uniformity of the slot height determines the uniformity of flow across the width of the coating.

The volumetric flow to the slot die is controlled by a positive displacement gear pump which provides uniform, pulse-free delivery according to the pump shaft speed.

This volumetric flow is spread uniformly across the established width by the slot die then drawn away at a fixed rate by the established line speed to create a constant wet coating thickness.

The paint coated nonwoven sheet is then passed through a 9.1 m (30 ft) length dryer oven with zones set at temperatures of 60° C., 80° C. and 90° C. Impinging air in the oven removes the volatile components from the paint and results in the formation of the binder layer comprising binder and scatterer of visible light dispersed in the binder.

The thickness of the resultant binder layer is approximately 60 μm.

Upon exiting the oven the diffuse reflector is wound up into roll form that ultimately can be slit into required widths and chopped into individual products of desired dimensions.

A total reflectance spectrum is obtained for multiple (i.e., at least twelve) 34 mm×34 mm square diffuse reflector samples by the aforementioned Spectrophotometer method and the R_{VIS} value calculated. Diffuse reflector sample spectra are averaged to determine an average reflectance spectrum and average R_{VIS} for each diffuse reflector. The average R_{VIS} of the diffuse reflector is 96.87%.

The line labeled 2 in FIG. 3 is a graph of the total reflectance spectrum (reflectivity (%) versus wavelength (nm)) for the EX. 1 diffuse reflector.

### Example 2

### Diffuse Reflector

The procedure of Example 1 is followed for this example with the following modifications.

The white acrylic latex paint is directly metered on to the moving nonwoven sheet surface at a rate of 60 cm³/min at a width of 33.0 cm (13 in) and wet thickness of about 40 μm. The thickness of the resultant binder layer after drying is approximately 15 μm. The average R_{VIS} of the diffuse reflector is 96.17%. The line labeled 3 in FIG. 3 is a graph of the total reflectance spectrum (reflectivity (%) versus wavelength (nm)) for the EX. 2 diffuse reflector.

### Example 3

### Diffuse Reflector

The procedure of Example 1 is followed for this example with the following modifications.

As earlier described in the section titled NONWOVEN SHEET UTILIZED IN EXAMPLES 1, 2 AND 3, the nonwoven sheet of EX. 3 contains about 10 weight percent of Ti-Pure® R-101 titanium dioxide particles dispersed in the polymer phase forming the nonwoven sheet fibers.

A white paint is prepared comprising 70 weight percent of the aforementioned Behr Premium Plus® Exterior Semi-Gloss Ultra Pure White No. 5050 and 30 weight percent of Ti-Pure® R-741 titanium dioxide slurry, available from DuPont Titanium Technologies, Del., USA. This white paint is coated on to the nonwoven sheet surface by the aforementioned slot die coating head method such that the coating weight of the resultant binder layer after drying is 42±5 g/m². A backing support sheet of 30 μm thick white PET sheet is laminated to the binder layer face of the diffuse reflector with a 5 μm thick layer of pressure sensitive adhesive to form a diffuse reflector having a backing support sheet.

The average R_{VIS} of this diffuse reflector having a backing support sheet of white PET is 96.4±0.9%, the reflectance at 550 nm is 98.0±0.7%, the color a* is −0.5, and the color b* is 0.7, as measured by the procedure of ASTM E 1164 (400 to 700 nm in 10 nm increments) using an X-Rite SP64 spectrophotometer and D65/10 illuminant/observer. The thickness of this diffuse reflector is 265±25 μm, as measured by the procedure of ASTM D374-99 using an Onko Sokki EG225 micrometer, base ST-022, finger lift AA-969, 8 mm diameter flat head gauge.

### Example 4

### Luminance of Direct View Backlight Utilizing a Diffuse Reflector

In this example, the luminance of a liquid crystal display backlight containing an EX. 1 or EX. 2 diffuse reflector is compared to the same backlight containing a commercially available diffuse reflector. Use of diffuse reflectors according to the present invention demonstrates increased uniformity at a reduced overall backlight thickness while maintaining overall brightness.

Table 1 reports average luminance (cd/m²), luminance standard deviation (cd/m², referred to herein as “sd”) and reflector average thickness for a commercial backlight unit containing EX. 1 or EX. 2 diffuse reflectors, or either of the commercial reflectors E60L and E6SV.

A 33 cm (13″) LCD television, model LC-13AV1U from Sharp Electronics Corporation, N.J., USA, is disassembled to obtain the backlight unit which includes a diffuse reflector sheet, two white injection molded end pieces, four U-shaped CCFLs, a diffuser sheet and a diffuser plate. The front surface of the backlight unit measures 220 mm by 290 mm. A black absorbing film is positioned over and completely covers the bottom portion of the backlight and existing diffuse reflector sheet during testing in this example to avoid the contribution to light reflection from the existing reflector in that area. EX. 1 and EX. 2 diffuse reflectors are produced in a size to fit the entire bottom face of the backlight unit cavity. A single EX. 1 or EX. 2 diffuse reflector is then positioned in the backlight unit on top of the black absorbing film with the nonwoven face of the EX. 1 or EX. 2 diffuse reflector facing the CCFLs and the backlight unit is then reassembled. The sidewalls of the backlight cavity are not modified. The backlight unit is then operated for 60 minutes to allow the unit to stabilize. The performance of the backlight unit containing EX. 1 or EX. 2 diffuse reflectors is measured using a Photo Research®, Inc., CA, USA, PR®-650 SpectraScan® spectraradiometer. The distance between the spectraradiometer and the backlight unit is 460 mm. Luminance (cd/m²) at normal incidence is measured with the spectraradiometer at the center point of the backlight unit, where the center point of the backlight is that point on the backlight opening that is exactly half the total width and half the total length of the backlight. A luminance measurement is taken 25 times, once every 20 seconds. Average luminance and uniformity are measured and compared to like measurements made on samples of individual commercial reflectors positioned in the backlight unit as described. The commercial reflectors examined are “E60L”, a 188 μm thick white PET reflector, and “E6SV”, a 255 μm thick white PET reflector, both sold by Toray Industries, Inc. of Chiba, Japan.

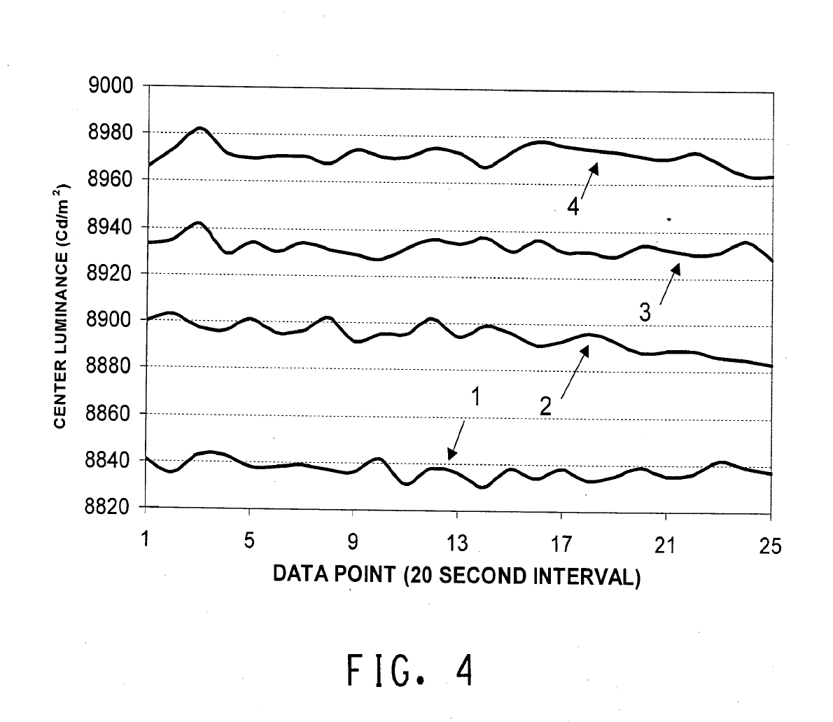

Luminance versus measurement position for the backlight unit containing each individual reflector is shown in FIG. 4. The line labeled 1 in FIG. 4 is a graph of the center luminance (Cd/m²) versus data point (20 second interval) for E60L. The line labeled 2 in FIG. 4 is a graph of the center luminance (Cd/m²) versus data point (20 second interval) for the EX. 2 diffuse reflector. The line labeled 3 in FIG. 4 is a graph of the center luminance (Cd/m²) versus data point (20 second interval) for the EX. 1 diffuse reflector. The line labeled 4 in FIG. 4 is a graph of the center luminance (Cd/m²) versus data point (20 second interval) for E6SV.

Average center luminance (cd/m₂) for the backlight unit containing single diffuse reflectors EX. 1, EX. 2, E60L and E6SV is summarized in Table 1.

TABLE 1

Diffuse Reflector

| | EX. 1 | EX. 2 | E60L | E6SV |
|---|---|---|---|---|
| Average | 8932 | 8894 | 8837 | 8988 |
| Center | | | | |
| Luminance | | | | |
| (cd/m²) | | | | |
| Sd | 3 | 5 | 3 | 4 |
| Reflector | 250 μm | 200 μm | 188 μm | 255 μm |
| Average | | | | |
| Thickness | | | | |

### Example 5

### Diffusivity of Diffuse Reflectors

The variation in light reflected from each of EX. 1, EX. 2, and comparative commercial reflectors E6SV and “MCPET” (an ultra-fine foam glass light reflection panel manufactured by Furukawa Electric Co., Ltd., Tokyo, Japan) is measured using a Eldim EZContrast XR88 conoscope available from Eldim, Herouville St. Clair, France, having a reflective attachment to allow incident collimated light at a fixed angle of 20 degrees from normal to the reflector plane. Diffuse reflectors of the present invention are placed in the conoscope with the nonwoven face of the diffuse reflector facing the conoscope light source. The variation in luminance is measured over the range of angles from −88 degrees to 88 degrees and over the full range of azimuthal angles from 0 to 360 degrees. Conoscopes (radial plots of luminance versus angle) of the four reflectors are shown in FIG. 5, wherein E6SV is plot labeled 1, MCPET is plot labeled 2, EX.1 is plot labeled 3, and EX.2 is plot labeled 4. The in-plane diffusion cone is measured by observing only the luminance in the plane containing the input collimated beam and specular reflectance. Results of this subset of the conoscope data is shown in FIG. 6, which is a plot of normalized luminance (luminance/peak luminance) versus angle with respect to specular at 20 degrees. Angular bandwidth is determined based on the two angles at which the luminance is 50% of peak luminance for each reflector and the typical angular bandwidth is shown in Table 2. The diffusivity of each diffuse reflector is quantified from this measurement.

TABLE 2

| | Angular |
|---|---|
| | Bandwidth at |
| | 50% Peak |
| Reflector | Luminance (deg) |
| E6SV | 2 |
| MCPET | <1 |
| EX. 1 | 135 |
| EX. 2 | 120 |

The dependence of the normalized luminance on reflected angle, a measure of the diffusivity for a reflector, is greater for the diffuser reflectors of the present invention than for comparative commercial diffuse reflectors. This results in increased scattering of light within the backlight and leads to better uniformity at reduced overall backlight thickness while maintaining overall brightness of optical displays utilizing diffuser reflectors of the present invention.

It is therefore, apparent that there has been provided in accordance with the present invention, a diffuse reflector, a diffuse reflective article, an optical display, and a method of improving light reflectivity in a device requiring diffuse reflectivity of light that fully satisfy the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A diffuse reflector of visible light comprising a nonwoven sheet having on at least one face thereof a binder layer comprising a binder and a scatterer of visible light dispersed in said binder.

2. The diffuse reflector of claim 1, wherein said nonwoven sheet comprises a plurality of plexifilamentary film-fibrils, wherein the fibrils comprise a polymer.

3. The diffuse reflector of claim 1, wherein said nonwoven sheet contains a plurality of pores, wherein the specific pore volume is at least about 10 cm³/m² for pores having a mean pore diameter as measured by mercury porosimetry of from about 0.01 μm to about 1.0 μm.

4. The diffuse reflector of claim 1, wherein said nonwoven sheet contains a plurality of pores, wherein the specific pore volume is at least about 40 cm³/m² for pores having a mean pore diameter as measured by mercury porosimetry of from about 0.01 μm to about 1.0 μm.

5. The diffuse reflector of claim 1, wherein said nonwoven sheet comprises polymer, said polymer further comprising from about 0.05 to about 50 weight percent particulate filler based on the weight of said polymer.

6. The diffuse reflector of claim 1, wherein said binder layer comprises polymer selected from the group consisting of polyurethanes, polyesters, acrylics and silicones.

7. The diffuse reflector of claim 1, wherein said binder is an adhesive.

8. The diffuse reflector of claim 1, wherein said nonwoven sheet has an average sheet thickness of about 150 μm to about 300 μm, and said binder layer is from about 5 μm to about 50 μm thick.

9. The diffuse reflector of claim 1 wherein said scatterer comprises a plurality of white pigment particles having a mean diameter of from about 0.1 μm to about 30 μm.

10. The diffuse reflector of claim 1, wherein said scatterer comprises a plurality of at least one white pigment particle selected from the group consisting of titanium oxide and zinc oxide.

11. The diffuse reflector of claim 1 wherein said scatterer comprises a plurality of voids having a mean diameter of from about 0.01 μm to about 1 μm.

12. The diffuse reflector of claim 11, wherein the porosity of said binder layer is about 55% or less.

13. The diffuse reflector of claim 1, wherein said scatterer comprises titanium dioxide particles having a mean diameter of from about 0.1 μm to about 30 μm present in said binder in an amount above the CPVC.

14. The diffuse reflector of claim 1 wherein the refractive index of said scatterer is at least about 2.5 and the difference in refractive index between said binder and said scatterer is at least about 0.5.

15. The diffuse reflector of claim 1 wherein at least one of said nonwoven sheet and said binder layer further comprises UV stabilizer.

16. The diffuse reflector of claim 1 comprising a plurality of nonwoven sheets forming a laminate, wherein at least one nonwoven sheet interface of said laminate contains said binder layer.

17. The diffuse reflector of claim 1 further comprising a backing support sheet laminated to said binder layer.

18. The diffuse reflector of claim 1, further comprising a specular reflective layer on said binder layer.

19. A diffuse reflective article comprising a diffuse reflector of visible light and a structure forming an optical cavity, wherein said diffuse reflector has a nonwoven face and is positioned within said optical cavity such that light reflects off of said nonwoven face, and wherein said diffuse reflector comprises a nonwoven sheet having on one face thereof a binder layer comprising a binder and a scatterer of visible light dispersed in said binder.

20. The diffuse reflective article of claim 19, further comprising a light source positioned within said optical cavity such that light from said light source reflects off of said nonwoven face of said diffuse reflector and out of said optical cavity

21. The diffuse reflective article of claim 20, further comprising a display panel through which light from said light source passes, wherein said diffuse reflector is positioned within said optical cavity to reflect light from said light source toward said display panel.

22. The diffuse reflective article of claim 20, wherein said diffuse reflector lines at least a portion of said optical cavity and partially wraps around said light source so as to direct light from said light source into said optical cavity.

23. The diffuse reflective article of claim 20, wherein said optical cavity includes a light guide, and wherein said diffuse reflector reflects light from said light source into said light guide.

24. An optical display, comprising:
(i) a structure defining an optical cavity;
(ii) a light source positioned within said optical cavity;
(iii) a display panel through which light from said light source passes; and
(iv) a diffuse reflector comprising a nonwoven sheet having on one face thereof a binder layer comprising a binder and a scatterer of visible light dispersed in said binder, said diffuse reflector positioned within said optical cavity to reflect light from said light source off of the nonwoven sheet face of said diffuse reflector toward said display panel.

25. A method of improving light reflectivity in a device requiring diffuse reflectivity of light comprising:
(i) providing a diffuse reflector comprising a nonwoven sheet having on at least one face thereof a binder layer comprising a binder and a scatterer of visible light dispersed in said binder; and
(ii) positioning said diffuse reflector within said device to cause light energy to reflect off of the nonwoven sheet face of said diffuse reflector.
